(19) United States
(12) Patent Application Publication
(10) Pub. No.: US 2023/0339168 A1
(43) Pub. Date: Oct. 26, 2023

(54) METHOD FOR MANUFACTURING POLYESTER FILM FOR EMBOSSING

(71) Applicant: NAN YA PLASTICS CORPORATION, TAIPEI (TW)

(72) Inventors: Wen-Cheng Yang, TAIPEI (TW); TE-CHAO LIAO, TAIPEI (TW); Chia-Yen Hsiao, TAIPEI (TW); Yu-Chi Hsieh, TAIPEI (TW)

(21) Appl. No.: 18/216,649

(22) Filed: Jun. 30, 2023

Related U.S. Application Data
(63) Continuation-in-part of application No. 17/201,199, filed on Mar. 15, 2021.

(30) Foreign Application Priority Data
Jul. 15, 2020 (TW) 109123798

(51) Int. Cl. B29C 59/00; C08J 11/10; B29C 48/00; B29C 48/07; C08J 7/04; C09D 167/03; C09D 7/61; C08K 3/36; C08K 3/22; C08J 11/06

(52) U.S. Cl. CPC B29C 59/005; C08J 11/10; B29C 48/022; B29C 48/07; B29C 48/0018; C08J 7/0427; C09D 167/03; C09D 7/61; C08K 3/36; C08K 3/22; C08J 11/06; C08K 2003/265

(57) ABSTRACT

A method for manufacturing a polyester film for embossing is provided. A polyester composition is prepared from a recycled polyester material. The polyester composition includes a physically regenerated polyester resin and a chemically regenerated polyester resin. The polyester composition is melted and extruded so as to form a base layer. The base layer is stretched in a machine direction. A surface coating paste is coated onto the base layer. The base layer with the surface coating paste is heated and stretched in a transverse direction, such that the surface coating paste turns into a surface coating layer, and a polyester film for embossing is obtained.

### CROSS-REFERENCE TO RELATED PATENT APPLICATION

This application is a continuation-in-part application of the U.S. patent application Ser. No. 17/201,199, filed on Mar. 15, 2021, and entitled “POLYESTER FILM FOR EMBOSSING AND METHOD FOR MANUFACTURING THE SAME,” now pending, the entire disclosures of which are incorporated herein by reference.

### FIELD OF THE DISCLOSURE

The present disclosure relates to a method for manufacturing a polyester film for embossing, and more particularly to a method for manufacturing a polyester film for embossing that is made from a recycled polyester material.

### BACKGROUND OF THE DISCLOSURE

In recent years, usage of plastics has increased significantly, and as a result, a large amount of plastic waste is produced. Since the plastics are not easily degraded, recycling of the plastics and how to process the plastics after recycling have become particularly important issues.

Polyethylene terephthalate (PET) makes up a major portion of recycled plastics, and recycled PET plastics takes up about 52.4% of a total amount of the recycled plastics. In order to deal with such a large amount of recycled PET plastics, researchers in relevant field have to dedicate themselves to developing a method for processing the recycled PET plastics.

Out of the current techniques, the most common method to regenerate PET is through a physical (mechanical) manner. The recycled PET plastics that have been washed clean are firstly shredded to pieces and melted under high temperature, and then are extruded by an extruder to produce regenerated PET chips (also called as r-PET).

To address environmental concerns and to ensure that PET products contain more eco-friendly regenerated PET chips, a large amount of high-quality recycled PET chips is required. In the current industry, the PET recycling is mostly carried out by way of physical recycling. However, functional components (such as a slipping agent and an electrostatic pinning additive) are not allowed to be added, during a manufacturing process, to recycle chips that are produced through physical recycling. Therefore, it is necessary to use additional virgin (not regenerated) PET chips for additionally adding the above-mentioned functional components.

However, after adding the virgin polyester chips, a usage rate of the regenerated PET chips contained in the PET products will decrease. That is to say, in the current techniques, it is not possible to fully utilize the regenerated PET chips to manufacture new PET products. If the usage rate of the regenerated PET chips is too low, it may not be possible to satisfy a standard set up by environmental regulations such that an eco-label can be obtained. Moreover, as virgin PET chips that are newly used in the process of manufacturing the PET products would subsequently become the regenerated PET plastics that require processing, a problem of recycling and reusing would still arise.

### SUMMARY OF THE DISCLOSURE

In response to the above-referenced technical inadequacies, the present disclosure provides a method for manufacturing a polyester film for embossing.

In one aspect, the present disclosure provides a method for manufacturing a polyester film for embossing. A polyester composition is prepared from a recycled polyester material. The polyester composition includes a physically regenerated polyester resin and a chemically regenerated polyester resin. The polyester composition is melted and extruded so as to form a base layer. The base layer is stretched in a machine direction. A surface coating paste is coated onto the base layer. The base layer with the surface coating paste is heated and stretched in a transverse direction, such that the surface coating paste turns into a surface coating layer, and a polyester film for embossing is obtained.

In certain embodiments, the polyester composition is consisting of the physically regenerated polyester resin and the chemically regenerated polyester resin.

In certain embodiments, based on a total weight of the polyester composition being 100 wt %, a content of the physically regenerated polyester resin ranges from 50 wt % to 95 wt %, and a content of the chemically regenerated polyester resin ranges from 5 wt % to 50 wt %.

In certain embodiments, the main resin includes a polyester resin.

In certain embodiments, an average diameter of the fillers ranges from 10 nm to 8 μm. The fillers include at least one of silicon dioxide, calcium carbonate, and aluminum oxide.

In certain embodiments, the hardener includes melamine, an epoxy resin hardener, or a polyurethane hardener.

In certain embodiments, a total thickness of the polyester film for embossing ranges from 8 μm to 350 μm. The surface coating layer is coated on the base layer. A thickness of the surface coating layer ranges from 0.05 μm to 24 μm.

In certain embodiments, the chemically regenerated polyester resin is formed from chemically regenerated polyester chips. The chemically regenerated polyester chips are formed by depolymerizing the recycled polyester material to obtain an oligomer mixture, repolymerizing the oligomer mixture, and then granulating the oligomer mixture to form the chemically regenerated polyester chips.

In certain embodiments, before being repolymerized, the oligomer mixture is filtered to have a polydispersity index ranging from 0.9 to 1.2.

In certain embodiments, the chemically regenerated polyester chips include chemically regenerated electrostatic pinning polyester chips, and the chemically regenerated electrostatic pinning polyester chips is formed by adding an electrostatic pinning additive into the oligomer mixture before the oligomer mixture is repolymerized.

In certain embodiments, the physically regenerated polyester resin is formed from physically regenerated polyester chips. The physically regenerated polyester chips are formed by melting the recycled polyester material to obtain a melted mixture, and molding the melted mixture to obtain the physically regenerated polyester chips.

In certain embodiments, the base layer and the surface coating layer are integrally formed.

In certain embodiments, a stretching ratio for the base layer in the machine direction ranges from 2.7 to 3.3.

In certain embodiments, a stretching ratio for the base layer with the surface coating paste in the transverse direction ranges from 2.7 to 3.5.

In certain embodiments, a stretching temperature for the base layer in the machine direction ranges from 105° C. to 120° C.

In certain embodiments, a stretching temperature for the base layer with the surface coating layer in the transverse direction ranges from 190° C. to 230° C.

In certain embodiments, an intrinsic viscosity of the physically regenerated polyester resin ranges from 0.75 dL/g to 1.0 dL/g, and an intrinsic viscosity of the chemically regenerated polyester resin ranges from 0.4 dL/g to 0.75 dL/g.

Therefore, by virtue of “stretching the base layer in a machine direction,” “coating a surface coating paste onto the base layer,” and “heating and stretching the base layer with the surface coating paste in a transverse direction,” the polyester film for embossing can have a stronger structural strength so as to prevent membrane rupture during a manufacturing process.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a side schematic view of a polyester film for embossing according to a first embodiment of the present disclosure;

FIG. 2 is a side schematic view showing a state of use of the polyester film for embossing according to the first embodiment of the present disclosure;

FIG. 3 is a side schematic view of a polyester film for embossing according to a second embodiment of the present disclosure;

FIG. 4 is a side schematic view of a polyester film for embossing according to a third embodiment of the present disclosure; and

FIG. 5 is a flowchart describing a method for manufacturing the polyester film for embossing of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

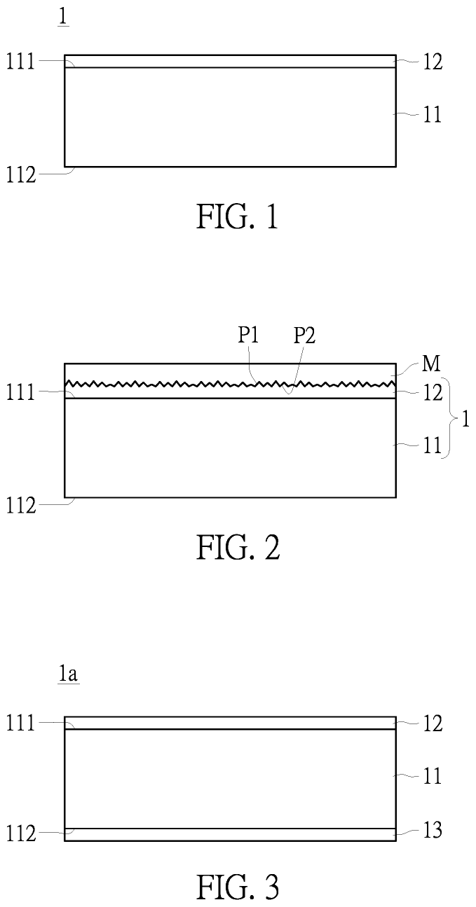

Referring to FIG. 1, a first embodiment of the present disclosure provides a polyester film for embossing 1. The polyester film for embossing 1 includes a base layer 11 and a surface coating layer 12. In an exemplary embodiment, the base layer 11 and the surface coating layer 12 are integrally formed.

The base layer 11 has a first surface 111 and a second surface 112 opposite to each other. The base layer 11 is flexible. The surface coating layer 12 is disposed on the first surface 111 of the base layer 11 by coating. In addition, the second surface 112 of the base layer 11 can undergo a corona treatment optionally. The surface coating layer 12 is an easy-to-press embossed pattern layer.

In the present embodiment, a thickness of the polyester film for embossing 1 ranges from 8 μm to 350 μm. A thickness of the surface coating layer 12 ranges from 0.05 μm to 24 μm.

Referring to FIG. 2, a three-dimensional embossed pattern P1 can be formed on a metal stamper M by laser engraving. Subsequently, the metal stamper M can be used to press against the surface coating layer 12 of the polyester film for embossing 1. If necessary, the metal stamper M can be heated to a predetermined temperature (such as 200° C.), so that the surface coating layer 12 has another three-dimensional embossed pattern P2 that is inverse to the three-dimensional embossed pattern P1 in unevenness. However, these details are provided for exemplary purposes only and are not meant to limit the scope of the present disclosure.

The base layer 11 is formed from a polyester composition. The polyester composition is formed from a recycled polyester material, such as to process recycled PET plastics for environmental protection. Specifically, the polyester composition includes a physically regenerated polyester resin and a chemically regenerated polyester resin. In an exemplary embodiment, the polyester composition is consisting of the physically regenerated polyester resin and the chemically regenerated polyester resin. In other words, the based layer 11 of the present application can be completely made from the recycled polyester material. A main component of each of the physically regenerated polyester resin and the chemically regenerated polyester resin is regenerated polyethylene terephthalate, but is not limited thereto.

Specifically, an intrinsic viscosity of the physically regenerated polyester resin ranges from 0.75 dL/g to 1.0 dL/g. An intrinsic viscosity of the chemically regenerated polyester resin ranges from 0.4 dL/g to 0.75 dL/g.

As for the polyester composition forming the base layer 11, based on a total weight of the polyester composition being 100 wt %, the polyester composition includes 50 wt % to 95 wt % of physically regenerated polyester resin, and 5 wt % to 50 wt % of chemically regenerated polyester resin. A total amount of the physically regenerated polyester resin and the chemically regenerated polyester resin ranges from 50 wt % to 100 wt %.

A material forming the surface coating layer 12 includes a main resin, fillers, and a hardener. The main resin is an acrylic resin, a polyurethane resin, or a polyester resin. Preferably, the main resin is a polyester resin such that the base layer 11 and the surface coating layer 12 can have strong connection force. The fillers include at least one of silicon dioxide, calcium carbonate, and aluminum oxide. A diameter of the fillers ranges from 10 nm to 8 μm. Specifically, based on a total weight of the surface coating layer 12 being 100 wt %, an amount of the main resin ranges from 60 wt % to 85 wt %, an amount of the fillers ranges from 0.1 wt % to 30 wt %, and an amount of the hardener ranges from 0.01 wt % to 3 wt %.

In the present disclosure, the polyester composition forming the base layer 11 contains both of the physically regenerated polyester resin and the chemically regenerated polyester resin. By using both of the physically regenerated polyester resin and the chemically regenerated polyester resin, a proportion of the recycled polyester material used in the base layer 11 can be increased, and even reach 100 wt %. In addition, even without being added with the virgin polyester chips, the polyester composition of the present disclosure will not have a problem of high impurity resulting from use of the physically regenerated polyester resin only.

Further, the aforementioned physically regenerated polyester resin is formed from one or many kinds of physically regenerated polyester chips. A main component of the physically regenerated polyester chips is regenerated polyethylene terephthalate. The aforementioned chemically regenerated polyester resin is formed from one or many kinds of chemically regenerated polyester chips. A main component of the chemically regenerated polyester chips is regenerated polyethylene terephthalate. The specific preparations of the physically regenerated polyester chips and the chemically regenerated polyester chips are illustrated later.

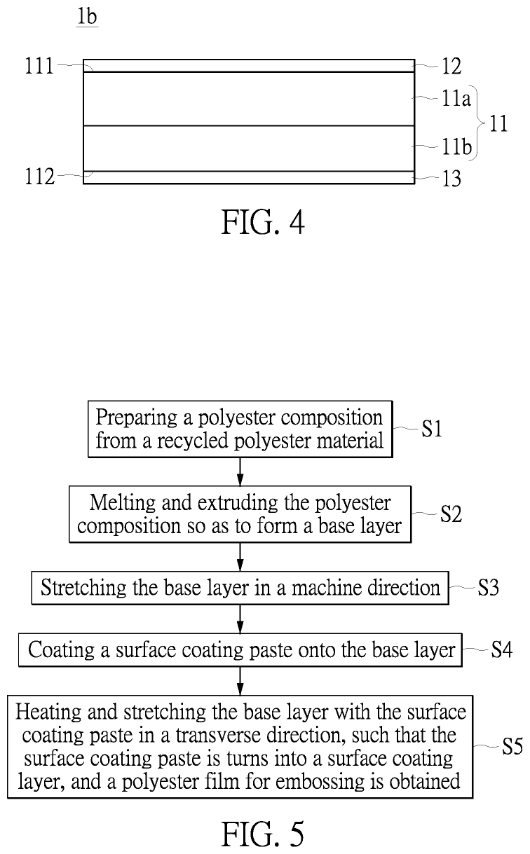

Referring to FIG. 5, a method for manufacturing the polyester film for embossing includes the following steps. A polyester composition is prepared from a recycled polyester material (step S1). The polyester composition is melted and extruded so as to form a base layer (step S2). The base layer is stretched in a machine direction (step S3). A surface coating paste is coated onto the base layer (step S4). The base layer with the surface coating paste is stretched in a transverse direction, such that the surface coating paste turns into a surface coating layer, and a polyester film for embossing is obtained (step S5). In step S1, the recycled polyester material can be recycled bottle chips. A main material of the recycled bottle chips is polyester. Generally, polyester is formed by a polycondensation of diol units and diacid units. In some embodiments, the main material of the recycled bottle chips is polyethylene terephthalate.

For recycled bottle chips, the diol units can be ethylene glycol derived from petrochemical sources or ethylene glycol derived from biomass. As for the polyester composition forming the base layer 11, based on the total weight of the polyester composition being 100 wt %, the polyester composition includes 1 wt % to 25 wt % of a biomass-derived material. In other words, a content of C¹⁴ among total carbon atoms in the polyester composition ranges from 0.2 wt % to 5 wt %.

The recycled polyester material can include isophthalic acid. Therefore, the polyester composition forming the base layer 11 may also contain isophthalic acid. Based on the total weight of the polyester composition being 100 wt %, the polyester composition contains 0.5 wt % to 5 wt % of isophthalic acid.

The recycled polyester material can include a metal catalyst. Therefore, the polyester composition forming the base layer 11 may also contain the metal catalyst. Based on the total weight of the polyester composition being 100 wt %, the polyester composition contains 0.0003 wt % to 0.04 wt % of the metal catalyst. The metal catalyst is selected from the group consisting of antimony, germanium, titanium, and any combination thereof.

The polyester composition includes a physically regenerated polyester resin and a chemically regenerated polyester resin. In an exemplary embodiment, the polyester composition is consisting of the physically regenerated polyester resin and the chemically regenerated polyester resin.

The physically regenerated polyester resin is formed from physically regenerated polyester chips. The physically regenerated polyester chips can be formed from the recycled polyester material by a physical reproduction process.

In a physical reproduction process, the recycled polyester material (such as bottle chips) is cut into pieces, and then melted to form a melted mixture. The melted mixture is extruded by a single-screw extruder or a twin-screw extruder, and then granulated to obtain the physically regenerated polyester chips.

In the present embodiment, the physically regenerated polyester chips include physically regenerated regular polyester chips. The physically regenerated regular polyester chips are polyester chips prepared through the physical reproduction process, and no functional additive is added during the physical reproduction process. In the present embodiment, a main component forming the physically regenerated regular polyester chips is regenerated polyethylene terephthalate.

In addition, in the physical reproduction process, functional additives (such as a slipping agent, a coloring agent, or a matting agent) can be added in the melted mixture, so that physically regenerated slipping polyester chips, physically regenerated color polyester chips, and physically regenerated matting polyester chips can be obtained. It should be noted that, a main component of each of the physically regenerated slipping polyester chips, the physically regenerated color polyester chips, and the physically regenerated matting polyester chips is regenerated polyethylene terephathalate.

The chemically regenerated polyester resin is formed from chemically regenerated polyester chips. The chemically regenerated polyester chips can be formed from the recycled polyester material by a chemical reproduction process.

In a chemical reproduction process, the recycled polyester material (such as bottle chips) is cut into pieces and then put in a chemical depolymerization solution, so that molecules of polyester will be broken into polyester monomer (such as diol unit and diacid unit) and oligomers (such as cyclic oligomer), and then an oligomer mixture is formed. The oligomer mixture is filtered and purified to have a polydispersity index ranging from 0.8 to 1.2. Subsequently, the oligomer mixture is repolymerized, and then granulated to obtain the chemically regenerated polyester chips. In the present embodiment, a main component forming the chemically regenerated polyester chips is regenerated polyethylene terephthalate.

In the present embodiment, the chemical depolymerization solution can be water, methanol, ethanol, ethylene glycol, diethylene glycol or any combination thereof. However, the present embodiment is not limited thereto. For example, water is used for hydrolysis, and methanol, ethanol, ethylene glycol, diethylene glycol are used for alcoholysis. In a preferable embodiment, the chemical depolymerization solution includes ethylene glycol.

In the present embodiment, the chemically regenerated polyester chips include the chemically regenerated regular polyester chips and the chemically regenerated electrostatic pinning polyester chips. The term “chemically regenerated regular polyester chips” refers to polyester chips prepared by direct repolymerization, reproduction process and no functional additive is added in the oligomer mixture during the chemical reproduction process. In the present embodiment, a component forming the chemically regenerated regular polyester chips is regenerated polyethylene terephthalate. The term “chemically regenerated electrostatic pinning polyester chips” refers to those prepared by having electrostatic pinning additives added into the oligomer mixture and then repolymerized. In the present embodiment, the chemically regenerated electrostatic pinning polyester chips include regenerated polyethylene terephthalate and the electrostatic pinning additives.

It should be noted that, the term “electrostatic pinning” refers to a use of materials that increase electrical conductivity or decrease electrical resistivity. The term “electrostatic pinning additives” in the present disclosure refers to materials that increase electrical conductivity or decrease electrical resistivity. The electrostatic pinning additives are metal salts. The metal salts can be sodium hydroxide, potassium hydroxide, or metal salts containing aliphatic carboxylic acid. In the metal salts containing aliphatic carboxylic acid, a carbon number of the aliphatic carboxylic acid ranges from 2 to 30. For instance, the aliphatic carboxylic acid (in the form of metal salts) contains monocarboxylic acid and dicarboxylic acid, such as acetic acid, palmitic acid, stearic acid, oleic acid or sebacic acid. In the present embodiment, the aliphatic carboxylic acid is preferably acetic acid. Further, a metal component of the metal salts can be, for example, alkali metal or alkaline earth metal. In other words, the metal salts can be, for example, lithium salts, sodium salts, potassium salts, manganese salts, zinc salts, calcium salts, magnesium salts, or aluminum salts. In the present embodiment, the metal salts are preferably manganese salts or lithium salts. The manganese salts can be magnesium acetate (Mg(CH₃COOH)₂), and the lithium salts can be lithium acetate (CH₃COOLi). However, the present disclosure is not limited thereto.

In addition, in the chemical reproduction process, the functional additives mentioned above (such as slipping agent, coloring agent, and matting agent) can be added into the oligomer mixture. Accordingly, after repolymerizing the oligomer mixture, chemically regenerated slipping polyester chips, chemically regenerated color polyester chips, and chemically regenerated matting polyester chips can be prepared sequentially. It should be noted that, a main component of each of the chemically regenerated slipping polyester chips, the chemically regenerated color polyester chips, and the chemically regenerated matting polyester chips is regenerated polyethylene terephthalate.

In steps S2 to S5, the polyester composition is melted and extruded via an extruder so as to form the base layer. For the base layer is made from the recycled polyester material, a structural strength of the base layer cannot be the same with a structural strength of a base layer made from virgin polyester chips. In order to enhance the structural strength of the base layer, the surface coating paste is coated onto the base layer in advance.

In steps S3 and S4, the surface coating paste is coated onto the base layer after the base layer is stretched in a machine direction, and then the base layer and the surface coating paste are stretched in a transverse direction together. In other words, the surface coating paste of the present disclosure is coated during a biaxial stretching process, instead of going through a biaxial stretching process and following a coating process. Therefore, the base layer can be protected and supported by the surface coating paste, so as to endure the processing. In addition, membrane rupture can be avoided.

In the present disclosure, the base layer is only heated once in the biaxial stretching process. The base layer does not need to be heated another time in the coating process for the surface coating layer. Therefore, a possibility of membrane rupture can be decreased.

In step S5, the base layer and the surface coating paste are heated and stretched together in a transverse direction. The surface coating paste is in a solution state. When the base layer is stretched, the surface coating paste is still coated on the base layer corresponding to the stretching of the base layer, without being separated from the base layer due to internal stress.

During the stretching process, the surface coating paste is heated, such that the surface coating paste is gradually turned into the surface coating layer due to the high temperature. Accordingly, there is almost no internal stress is stored in the surface coating layer. Moreover, the base layer and the surface coating layer can be integrally formed and have strong connection force.

The surface coating layer is formed from the surface coating paste. Accordingly, the polyester film for embossing including the base layer and the surface coating layer are obtained.

In an exemplary embodiment, the main resin of the surface coating paste is a polyester resin which is similar to a material of the base layer. Accordingly, the surface coating paste and the base layer can have strong connection force and similar expansion coefficients. The similar expansion coefficients can also decrease the possibility of membrane rupture.

Even disposing the surface coating paste to protect and support the base layer, membrane rupture still can happen during the biaxial stretching process. The structural strength of the base layer still cannot be the same with a structural strength of a base layer made from virgin polyester chips. Therefore, the parameters operated in the method for manufacturing the polyester film for embossing should be finely controlled.

In step S3, a stretching ratio for the base layer in the machine direction ranges from 2.7 to 3.3, and a stretching temperature for the base layer in the machine direction ranges from 105° C. to 120° C.

In step S4, a stretching ratio for the base layer and the surface coating paste in the transverse direction ranges from 2.7 to 3.5, and a stretching temperature for the base layer and the surface coating layer in the transverse direction ranges from 190° C. to 230° C.

When the stretching ratio is out of the range mentioned above, the membrane rupture will happen, or the surface coating layer will separate from the base layer.

For example, in a Comparative Example, the polyester composition includes 100 wt % of the physically regenerated polyester resin and 0 wt % of the chemically regenerated polyester resin. The polyester composition is melted and extruded to form a base layer which has a thickness of 12 μm, and then stretched by a stretching ratio of 3.5 in the machine direction at 120° C. A surface coated paste containing 80 wt % of the polyester resin, 18 wt % of the fillers, and 2 wt % of melamine is coated onto the base layer. Subsequently, the base layer with the surface coated paste is heated at a stretching temperature of 230° C. and stretched by a stretching ratio of 3.5 in the transverse direction. However, the base layer and the surface coated layer are ruptured.

In addition, the surface coating paste is in a paste state so that a heating temperature (the stretching temperature) for solidifying is higher than normal stretching temperatures. Therefore, the parameters operated in a biaxial stretching process should be finely controlled.

For the method previously mentioned, the surface coating layer needs to be stretchable to avoid membrane rupture. Based on a total weight of the surface coating layer being 100 wt %, the surface coating layer includes 60 wt % to 85 wt % of the main resin, 0.1 wt % to 30 wt % of the fillers, and 0.01 wt % to 3 wt % of the hardener.

In some exemplary embodiment, the amount of the main resin can be 65 wt %, 70 wt %, 75 wt %, or 80 wt %. The amount of the fillers can be 5 wt %, 10 wt %, 15 wt %, 20 wt %, or 25 wt %. The amount of the hardener can be 0.05 wt %, 0.1 wt %, 0.5 wt %, 1.0 wt %, 1.5 wt %, 2.0 wt %, or 2.5 wt %.

### Second Embodiment

Referring to FIG. 3, a second embodiment of the present disclosure provides a polyester film for embossing 1a. The polyester film for embossing 1a includes a base layer 11, a surface coating layer 12, and another surface coating layer 13. The base layer 11 has a first surface 111 and a second surface 112 opposite to each other. The surface coating layer 12 is coated and formed on the first surface 111 of the base layer 11. The surface coating layer 13 is coated and formed on the second surface 112 of the base layer 11. The surface coating layer 12 and the surface coating layer 13 are each an easy-to-press embossed pattern layer. A three-dimensional embossed pattern (not shown in the figure) can be formed onto each of the surface coating layer 12 and the surface coating layer 13. The three-dimensional embossed pattern formed onto the surface coating layer 12 can be the same or different from the three-dimensional embossed pattern formed onto the surface coating layer 13.

A material of the base layer 11 and a material of the surface coating layer 12 in the second embodiment is similar to the material of the base layer 11 and the material of the surface coating layer 12 in the first embodiment. Therefore, the specific content is not repeated herein.

The method for manufacturing the polyester film for embossing 1a is similar to that in the first embodiment, so it is not repeated herein.

### Third Embodiment

Referring to FIG. 4, a third embodiment of the present disclosure provides a polyester film for embossing 1b. The polyester film for embossing 1b in the third embodiment is similar to the polyester film for embossing 1a in the second embodiment. The difference is that the base layer 11 in the third embodiment includes a first base layer 11a and a second base layer 11b stacked upon each other. A composition of the first base layer 11a can be the same or different from a composition of the second base layer 11b. For example, the first base layer 11a and the second base layer 11b can be formed from different polyesters, or the functional additives added in the first base layer 11a can be different from the functional additives added in the second base layer 11b. The method for manufacturing the polyester film for embossing 1b is similar to that in the first embodiment, so it is not repeated herein.

### Beneficial Effects of the Embodiments

In conclusion, in the polyester film for embossing 1 and the method for manufacturing the same provided in the present disclosure, by virtue of “stretching the base layer in a machine direction,” “coating a surface coating paste onto the base layer,” and “heating and stretching the base layer with the surface coating paste in a transverse direction”, the polyester film for embossing can have a stronger structural strength so as to prevent membrane rupture during a manufacturing process.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a polyester film for embossing, comprising:
preparing a polyester composition from a recycled polyester material; the polyester composition including a physically regenerated polyester resin and a chemically regenerated polyester resin;
melting and extruding the polyester composition so as to form a base layer;
stretching the base layer in a machine direction;
coating a surface coating paste onto the base layer; and
heating and stretching the base layer with the surface coating paste in a transverse direction, such that the surface coating paste is turned into a surface coating layer, and a polyester film for embossing is obtained.

2. The method according to claim 1, wherein the polyester composition is consisting of the physically regenerated polyester resin and the chemically regenerated polyester resin.

3. The method according to claim 1, wherein, based on a total weight of the polyester composition being 100 wt %, a content of the physically regenerated polyester resin ranges from 50 wt % to 95 wt % and a content of the chemically regenerated polyester resin ranges from 5 wt % to 50 wt %.

4. The method according to claim 1, wherein a material of the surface coating layer includes a main resin, fillers, and a hardener, wherein, based on a total weight of the surface coating layer being 100 wt %, an amount of the main resin ranges from 60 wt % to 85 wt %, an amount of the fillers ranges from 0.1 wt % to 30 wt %, and an amount of the hardener ranges from 0.01 wt % to 3 wt %.

5. The method according to claim 4, wherein the main resin includes a polyester resin.

6. The method according to claim 4, wherein an average diameter of the fillers ranges from 10 nm to 8 μm, and the fillers include at least one of silicon dioxide, calcium carbonate, and aluminum oxide.

7. The method according to claim 4, wherein the hardener includes melamine, an epoxy resin hardener, or a polyurethane hardener.

8. The method according to claim 1, wherein a total thickness of the polyester film for embossing ranges from 8 μm to 350 μm, the surface coating layer is coated on the base layer, and a thickness of the surface coating layer ranges from 0.05 μm to 24 μm.

9. The method according to claim 1, wherein the chemically regenerated polyester resin is formed from chemically regenerated polyester chips, the chemically regenerated polyester chips are formed by depolymerizing the recycled polyester material to obtain an oligomer mixture, repolymerizing the oligomer mixture, and then granulating the oligomer mixture to form the chemically regenerated polyester chips.

10. The method according to claim 9, wherein, before being repolymerized, the oligomer mixture is filtered to have a polydispersity index ranging from 0.9 to 1.2.

11. The method according to claim 9, wherein the chemically regenerated polyester chips include chemically regenerated electrostatic pinning polyester chips, and the chemically regenerated electrostatic pinning polyester chips is formed by adding an electrostatic pinning additive into the oligomer mixture before the oligomer mixture is repolymerized.

12. The method according to claim 1, wherein the physically regenerated polyester resin is formed from physically regenerated polyester chips, and the physically regenerated polyester chips are formed by melting the recycled polyester material to obtain a melted mixture, and molding the melted mixture to obtain the physically regenerated polyester chips.

13. The method according to claim 1, wherein the base layer and the surface coating layer are integrally formed.

14. The method according to claim 1, wherein a stretching ratio for the base layer in the machine direction ranges from 2.7 to 3.3.

15. The method according to claim 1, wherein a stretching ratio for the base layer with the surface coating paste in the transverse direction ranges from 2.7 to 3.5.

16. The method according to claim 1, wherein a stretching temperature for the base layer in the machine direction ranges from 105° C. to 120° C.

17. The method according to claim 1, wherein a stretching temperature for the base layer with the surface coating layer in the transverse direction ranges from 190° C. to 230° C.

18. The method according to claim 1, wherein an intrinsic viscosity of the physically regenerated polyester resin ranges from 0.75 dL/g to 1.0 dL/g, and an intrinsic viscosity of the chemically regenerated polyester resin ranges from 0.4 dL/g to 0.75 dL/g.
